(19) United States
(12) Patent Application Publication
(10) Pub. No.: US 2004/0237607 A1
(43) Pub. Date: Dec. 2, 2004

(54) Lock particularly for cargo compartments of motor vehicles

(76) Inventor: Lorenzo Lorusso, Altamura (IT)

Correspondence Address: Abelman Frayne & Schwab, 150 East 42nd Street, New York, NY, 10017, US

(21) Appl. No.: 10/488,841

(22) PCT Filed: Aug. 30, 2002
(86) PCT No.: PCT/IT02/00561

(30) Foreign Application Priority Data
Sep. 5, 2001 (IT) RM2001A000535

(51) Int. Cl. E05B 13/00

(52) U.S. Cl. 70/208; 70/210

(57) ABSTRACT

A lock particularly for cargo compartments of motor vehicles, comprising in combination a housing (1), a rotating articulated handle (2), a rotating latch (3), a central pivot (4) transmitting the rotation from handle (2) to latch (3), and an elastic perforated “cap”(5), characterized in that all of the parts are of plastic material and are held together by the central pivot (4) by a nut screwed to one threaded end (13) thereof and a small transversal pin inserted in a suitable hole arranged at the opposite of the central pivot (4), said latch (3) being provided with a projection in one piece with its main body able to cooperate with closure key means to block the rotation of the latch.

The present invention relates essentially components for automotive vehicles and particularly improvements in a lock for opening/closing cargo compartments of motor vehicles.

Locks of such kind also provided with a key and a rotating latch able to engage a fixed member to lock the door are currently known.

Such rotating latch is moved by a preferably T-shaped handle which is able to rotate perpendicular to the latch rotation axis and to take a position parallel to the external surface of the cargo compartment, thus reducing the overall dimensions.

These known locks, however, have a lot of drawbacks even if they perform their duty.

One drawback of such known locks is that they are fully made of metal and then have a high manufacturing cost as well as corrosion problems so that they require lubrication and onerous maintenance.

A second drawback is that they consist of a large number of parts that have to be manufactured with high precision and assembled with care to reduce both friction and clearance as well as vibrations (as they are installed on motor vehicles).

A third drawback depending on the preceding one is that the large number of parts requires a specialized labour for their assembling and limits the productivity rating, thus charging further the production cost.

The main object of the present invention is then to overcome the drawbacks and the problems of the prior art and to reduce the number of parts which the lock consists of, thus making the assembling easier.

Another object of the invention is to limit the production cost by using high-resistance plastic materials that strongly reduce the need of maintenance and lubrication and vibrations as well.

This is achieved according to the invention by providing a lock of plastic material including components having such a structure and shape as to allow a handle with a very reduced number of parts to be manufactured.

A better understanding of the invention will result from the following detailed description with reference to the accompanying drawings that show some preferred embodiments thereof only by way of a not limiting example.

In the drawings:

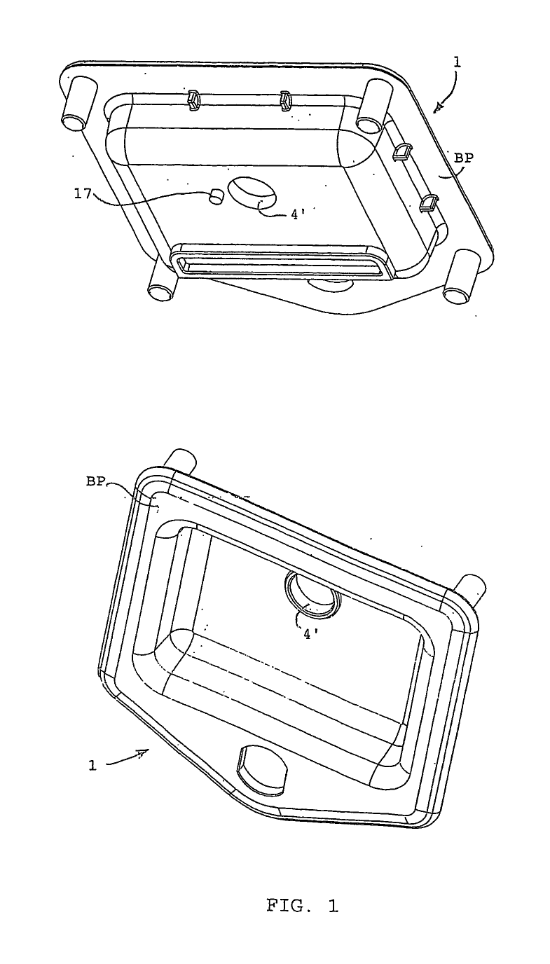

FIG. 1 shows front and rear axonometric views of the housing of a preferred embodiment of the invention;

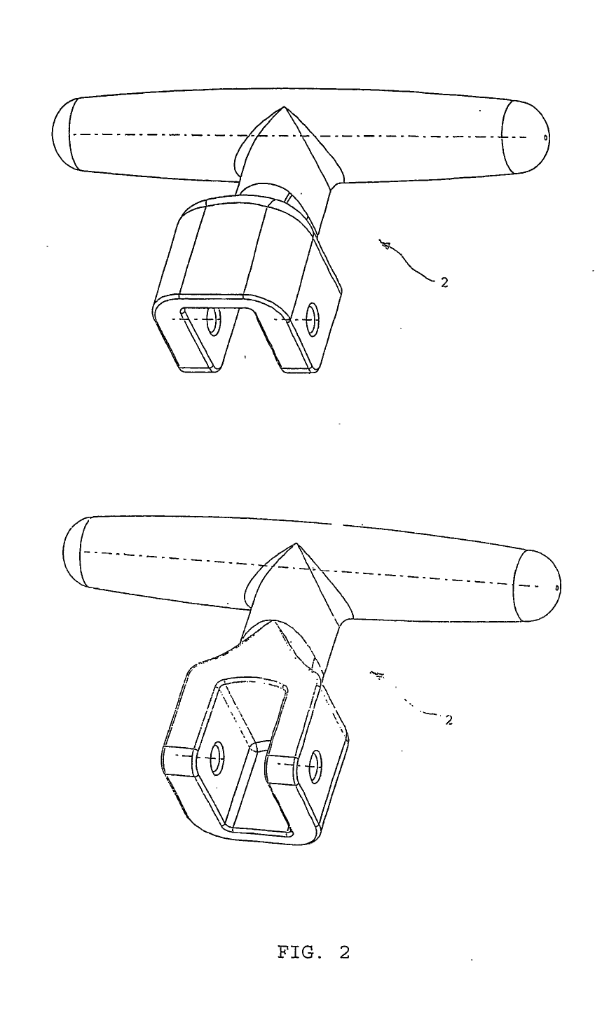

FIG. 2 is a view similar to the preceding one of the lock operating handle;

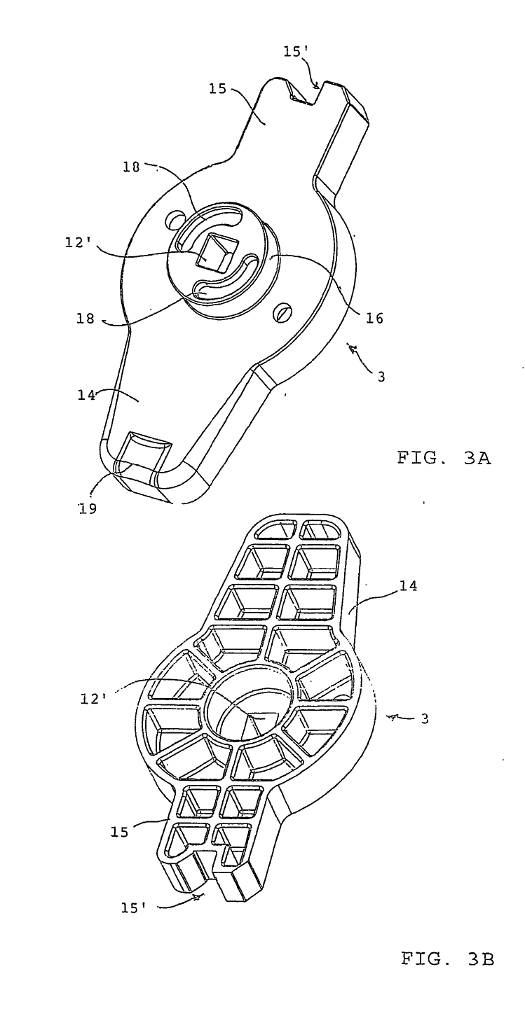

FIGS. 3A and 3B are front and rear axonometric views of the rotating latch of the lock;

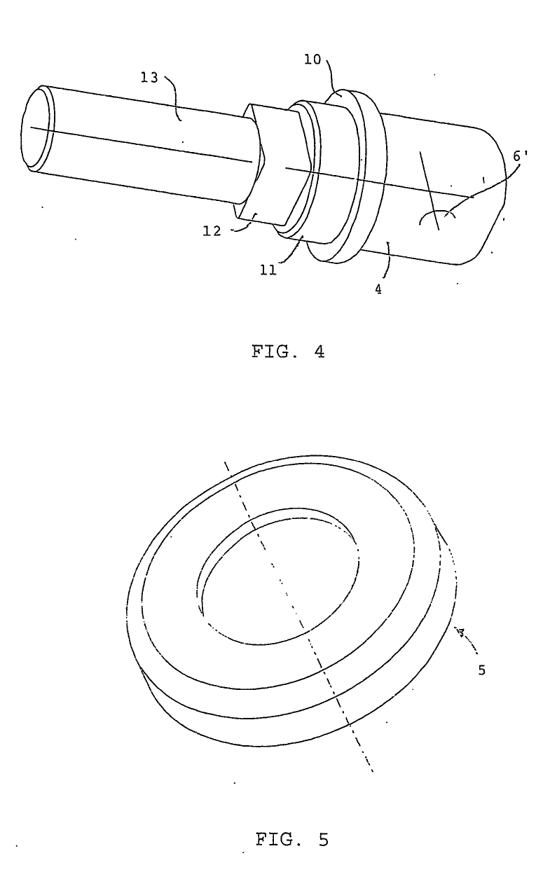

FIGS. 4 and 5 are axonometric views of further parts of the lock: the central pivot and the cap;

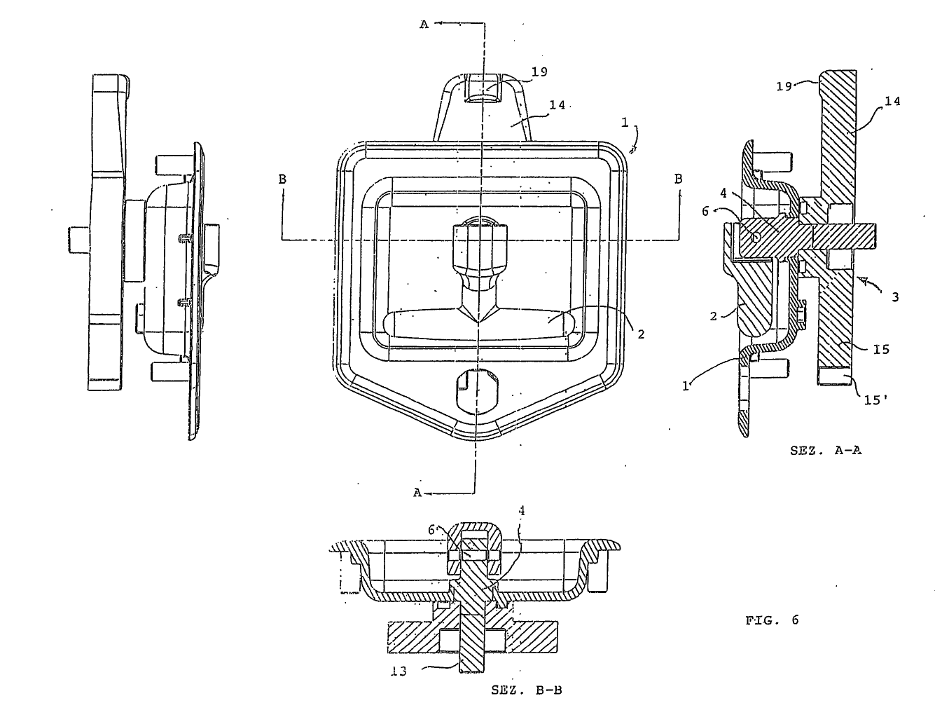

FIG. 6 shows front and side views of the whole lock together with two sections along the (vertical and horizontal) lines A-A and B-B through the axis of the central pivot;

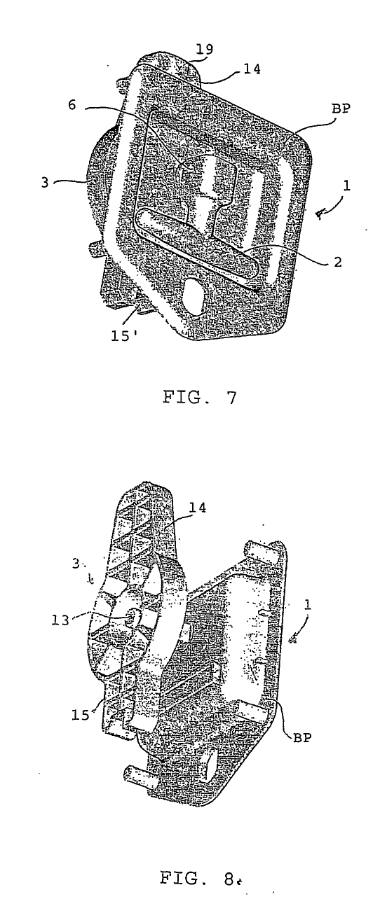

FIGS. 7 and 8 are front and rear solid axonometric views of the lock in assembled condition.

With reference to the above figures the described lock includes essentially: a housing 1, a rotating articulatd handle 2, a rotating latch 3, a central pivot 4 transmitting the rotation from handle 2 to latch 3, and an elastic perforated “cap” 5.

According to a peculiar feature of the invention, all of the parts are held together by the central pivot 4 by a common nut (of the known type) screwed to one threaded end 13 thereof and a small transversal pin 6 inserted in a suitable hole 6′ arranged at the opposite end of the central pivot 4.

With particular reference to FIG. 1, housing 1 is essentially shaped like a square or rectangular cup having a cavity with reduced height and a peripheral edge BP with enough width to receive fastening screws. According to the present invention, the assembling of the lock is carried out by inserting pivot 4 into a hole 4′ arranged at the centre of the bottom of housing 1 so that a shoulder 10 arranged around the central portion of pivot 4 abuts against the edge of hole 4′.

Adjacent to such shoulder 10 pivot 4 has a cylindrical portion with circular section 11 having a diameter which is essentially equal to the diameter of central hole 4′ and followed by a portion 12 with polygonal section inscribed in the above circular section 11 of the cylindrical portion and by the threaded end 13 of pivot 4 having a circular section inscribed in the polygonal section of the preceding portion 12. The length of the cylindrical portion with circular section 11 is equal to the thickness of the bottom of housing 1 in which hole 4′ is provided.

Rotating latch 3 having a generally elongated flat body lying on a plane perpendicular to central pivot 4 is inserted into threaded end 13 of pivot 4 until the position of portion 12 with polygonal section is reached. For this purpose the body of latch 3 is provided with a central hole 12′ with a shape mating the polygonal portion 12 of pivot 4 and at least an upper arm 14 able to engage a fixed portion (not shown) of the cargo compartiment.

Latch 3 is then blocked by the already mentioned nut of the known type so that the latch and the central pivot are rigidly connected to each other and the rotation of pivot 4 about its own longitudinal axis causes a corresponding rotation of latch 3.

With particular reference to FIG. 3, a latch portion 16 located about the central polygonal hole 12′ of latch 3 is raised with respect to the body of latch 3, such portion 16 having such an increased height as to allow latch 3 and housing 1 to lie on two separate parallel planes that are orthogonal to the longitudinal axis of central pivot 4.

In a preferred embodiment the height or thickness of portion 16 is preferably between 21 and 28 mm.

In order to limit the (rotary) movement of latch 3 with respect to housing 1, such raised portion 16 of the latch is provided with at least one arched groove 18, the centre of which coincides with the longitudinal axis of central pivot 4 and in which a pawl 17 arranged on the rear surface of housing 1 is placed. Groove 18 extends preferably by an arch of about 90°.

In the embodiment shown, the rotation movement to open/close the cargo compartment is imparted to central pivot 4 by an articulated, preferably T-shaped handle 2 which is hinged at the non-threaded end of central pivot 4 by a transversal pin 6 allowing the handle to rotate only about an axis orthogonal to the longitudinal rotation axis of pivot 4.

In order to keep handle 2 in its working and rest positions, the invention provides a suitable elastic perforated circular “cup” or “cap” 5 which is placed on central pivot 4 between handle 2 and the front surface of the cavity of housing 1. According to the present invention, whenever the user rotates handle 2 about transversal pin 6 to bring the same to the working position or back to the rest position into the cavity of housing 1, the cup or cap 5 is elastically deformed so as to oppose to any change of position of the handle. For this purpose cup 5 has such a height as to cause a not excessive elastic deformation so that the user should not make an useless high effort to bring handle 2 from the working to the rest position and vice versa.

Advantageously, in order to lighten rotating latch 3 and to keep it rigid enough, open cavities are arrranged in its rear side with such a geometry as to form longitudinal and transversal stiffening ribs (FIG. 3B).

Still according to the present invention there is also provided a closure by key C provided with a rotating member able to take two positions as requested: one opening position that does not interfere with the moviment of latch 3; and a closure position in which latch 3 is blocked without rotating about the longitudinal axis of central pivot 4.

According to the invention the latch is blocked by means of its lower arm 15 at the free end of which a recess 15′ is formed in which said rotating member of key C is inserted in the closed position.

It is self-evident from the foregoing that latch 3 performs at the same time the functions of real latch and closure of the lock as it is provided with means engaging the rotating member of the removable key C.

At last, in case it is not necessary to have a closure by a key C, it is sufficient not to install the latter or not to provide the lower arm 15 of the rotating latch 3 which only cooperates with the closure means.

It should be appreciated that the non-threaded end of central pivot 4, to which handle 2 is hinged, has preferably two flat surfaces parallel to the longitudinal axis and crossed by the already described transversal hole 6′ perpendicular thereto, in which a pin 6 is inserted about which handle 2 rotates from the working position to the rest position and vice versa.

In order to limit friction and the effort requested to open/close the lock, the free end of arm 14 of latch 3 is advantageously provided with a bulge 19 with a little surface able to slide on a fixed portion of the cargo compartment of the motor vehicle, thus generating a restricted friction.

The present invention has been described and illustrated according to a preferred embodiment thereof, however, it should be understood that those skilled in the art can make equivalent modifications and/or replacements without departing from the scope of the appended claims.

1. An improved lock particularly for cargo compartments of motor vehicles, comprising in combination a housing (1), a rotating articulatd handle (2), a rotating latch (3), a central pivot (4) transmitting the rotation from handle (2) to latch (3), and an elastic perforated “cap” or “cup” (5), characterized in that all of the parts are of plastic material and are held together by the central pivot (4) by a common nut (of the known type) screwed to one threaded end (13) thereof and a small transversal pin (6) inserted in a suitable hole (6′) arranged at the opposite end of the central pivot (4), said latch (3) being provided with a projection in one piece with its main body able to cooperate with closure key means (C) to block the rotation of the latch.

2. The lock according to claim 1, characterized in that pivot (4) is inserted into a hole (4′) arranged essentially at the centre of housing (1) so that a shoulder (10) arranged around the central portion of pivot (4) abuts against the edge of hole (4′).

3. The lock according to the preceding claim, characterized in that adjacent to shoulder (10) pivot (4) has a cylindrical portion with circular section (11) having a diameter essentially equal to the diameter of central hole (4′) and followed by a portion (12) with polygonal section inscribed in the above circular section (11) of the cylindrical portion and by the threaded end (13) of pivot (4) having a circular section inscribed in the polygonal section of the preceding portion (12), the length of the cylindrical portion with circular section (11) is equal to the thickness of the bottom of housing (1) in which hole (4′) is provided.

4. The lock according to the preceding claim, characterized in that rotating latch (3) having a generally elongated flat body lying on a plane perpendicular to central pivot (4) is inserted into threaded end (13) of pivot (4) until the position of portion (12) with polygonal section is reached, the body of latch (3) being provided for this purpose with a central hole (12′) with a shape mating the polygonal portion (12) of pivot (4) and at least an upper arm (14) able to engage a fixed portion (not shown) of the cargo compartiment.

5. The lock according to the preceding claim, characterized in that latch (3) is blocked in its position by the already mentioned nut so that the latch and the central pivot are rigidly connected to each other and the rotation of pivot (4) about its own longitudinal axis causes a corresponding rotation of latch (3).

6. The lock according to the preceding claim, characterized in that a latch portion (16) located about the central polygonal hole (12′) of latch (3) is raised with respect to the body of latch (3), said portion (16) having such an increased height as to allow latch (3) and housing (1) to lie on two separate parallel planes that are orthogonal to the longitudinal axis of central pivot (4).

7. The lock according to the preceding claim, characterized in that the height or thickness of portion (16) is preferably between 21 and 28 mm.

8. The lock according to one or more of the preceding claims, characterized in that in order to limit the (rotary) movement of latch (3) with respect to housing (1), such raised portion (16) of the latch is provided with at least one arched groove (18), the centre of which coincides with the longitudinal axis of central pivot (4) and in which a pawl (17) arranged on the rear surface of the housing is placed.

9. The lock according to the preceding claim, characterized in that groove (18) extends preferably by an arch of about 90°.

10. The lock according to one or more of the preceding claims, characterized in that housing (1) is essentially shaped like a square or rectangular cup having a cavity with reduced height and a peripheral edge (BP) with enough width to receive fastening screws.

11. The lock according to the preceding claim, characterized in that the rotation movement to open/close the cargo compartment is imparted to central pivot (4) by an articulated, preferably T-shaped handle (2) which is hinged at the non-threaded end of central pivot (4) by a transversal pin (6). allowing the handle to rotate only about an axis orthogonal to the longitudinal rotation axis of pivot (4).

12. The lock according to one or more of the preceding claims, characterized in that in order to keep handle (2) in its working and rest positions, there is provided a suitable elastic perforated circular “cup” or “cap” (5) which is placed on central pivot (4) between handle (2) and the front surface of the cavity of housing (1) so that whenever the user rotates handle (2) about transversal pin (6) to bring the same to the working position or back to the rest position into the cavity of housing (1), the cup or cap (5) is elastically deformed so as to oppose to any change of position of the handle.

13. The lock according to the preceding claim, characterized in that the height of cup or cap (5) is such as to cause a not excessive elastic deformation so that the user should not make an useless high effort to bring handle (2) from the working to the rest position and vice versa.

14. The lock according to one or more of the preceding claims, characterized in that in order to lighten rotating latch (3) and to keep it rigid enough, open cavities are arrranged in its rear side with such a geometry as to form longitudinal and transversal stiffening ribs

15. The lock according to one or more of the preceding claims, characterized in that there is provided a closure by key (C) provided with a rotating member able to take two positions as requested: one opening position that does not interfere with the movement of latch (3); and a closure position in which latch (3) is blocked without rotating about the longitudinal axis of central pivot (4), the latch being blocked by means of its lower arm (15) at the free end of which a recess (15′) is formed in which said rotating member of key (C) is located in the closed position.

16. The lock according to one or more of the preceding claims, characterized in that the non-threaded end of central pivot (4), to which handle (2) is hinged, has preferably two flat surfaces parallel to the longitudinal axis and crossed by the already described transversal hole (6′) perpendicular thereto, in which pin (6) is inserted about which handle (2) rotates from the working position to the rest position and vice versa.

17. The lock according to one or more of the preceding claims, characterized in that in order to limit friction and the effort requested to open/close the lock, the free end of arm (14) of latch (3) is advantageously provided with a bulge (19) with a little surface able to slide on a fixed portion of the cargo compartment of the motor vehicle, thus generating a restricted friction.
